(19) United States
(12) Patent Application Publication
(10) Pub. No.: US 2009/0210225 A1
(43) Pub. Date: Aug. 20, 2009

(54) SUPPORTING ELECTRONIC TASK MANAGEMENT SYSTEMS VIA TELEPHONE

(75) Inventors: Russell L. Simpson, Kirkland, WA (US); Clifford N. Didcock, Sammamish, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/032,369

(22) Filed: Feb. 15, 2008

(51) Int. Cl. G10L 15/26; H04M 1/64

(52) U.S. Cl. 704/235; 379/88.12; 704/E15.043

(57) ABSTRACT

The disclosed personal information management (PIM) system supports tasks and reminders via a audio user interface. The user creates a task object via a telephone call to the server. The task object may include an audio recording of the user's voice received during the telephone call. The system may convert the user's speech to text and may store the text in the task object. The system may include other structured data further defining the task such as calling party number, due date, start date, priority, status, percentage complete, categories, or the like. As stored by the system, the task may appear with the user's other tasks in the user's client. The PIM system may provide outbound telephone calls to the user as reminders associated with the user's tasks. The user receiving the reminder call may hear voice prompts, computer generated speech, and/or the audio recording associated with the task.

### BACKGROUND

The demands of personal productivity often drive people to make “to-do” lists. The lists may include tasks, actions to be taken and/or projects to complete. Many people maintain task lists using personal information management (PIM) systems, such as Microsoft Exchange, which is a PIM server, and Microsoft Outlook, which is a PIM client. Typically, users can create, edit, and display tasks via the PIM client on a computer. Optionally, users may receive computer-based notifications as reminders according to due dates associated with the items in the to-do list. These existing systems generally require direct computer access. These systems are less effective for users away from the computer or away from their regular workspaces. These systems are less effective for office workers during non-business hours.

However, personal productivity isn't confined to a desk or to regular business hours. A user may wish to capture new tasks directly to the PIM system while away from the office and/or away from a computer. Present unified messaging systems provide telephony access to a limited set of PIM functions, such as voice mail, e-mail, and calendar. It would be desirable, therefore, if systems and methods were available to provide support for to-do lists, tasks, and reminders without a need for the user to access a computer.

### SUMMARY

The disclosed systems and methods support to-do lists, tasks, and reminders via a audio user interface. The disclosed system enables a user to place a telephone call to the PIM system and capture a task item. The telephone user interface may provide voice prompts asking for user input. The user may provide input by speaking an audible response to the prompt. The user may provide input by pressing a key on the telephone sounding a dual tone multiple frequency (DTMF) tone. Then, the task may be processed and stored by the PIM system. The task may appear with the user's other tasks in the user's PIM client. Furthermore, the user may review and/or edit existing tasks via the telephone interface.

The new task may include an audio recording of the user's voice received during the telephone call. The new task may include a textual version of the audio recording. The new task may include structured data further defining the task such as calling party number, due date, start date, priority, status, percentage complete, categories, or the like. The structured data may be defined by the user during the telephone call. The structured data may be populated automatically by the PIM server according to a rule set.

The disclosed system may enable notifications (a.k.a., “reminders”) associated with the user's tasks. The PIM system may initiate an outbound telephone call to the user. The user receiving the call may listen to voice prompts, computer generated speech, and/or the audio recording associated with the task.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example computing environment in which example embodiments and aspects may be implemented.

FIG. 2 is a block diagram of an example personal information management (PIM) system for creating task objects via an audio user interface.

FIG. 3 is an example graphical user interface for task objects.

FIG. 4 is a flow chart depicting an example process for creating task objects by an audio user interface.

FIG. 5 is a flow chart depicting an example process for a reminder notification by an audio user interface.

FIG. 6 is a block diagram of an example personal information management (PIM) system for creating task objects and for initiating a reminder notification.

### DETAILED DESCRIPTION

### Exemplary Computing Arrangement

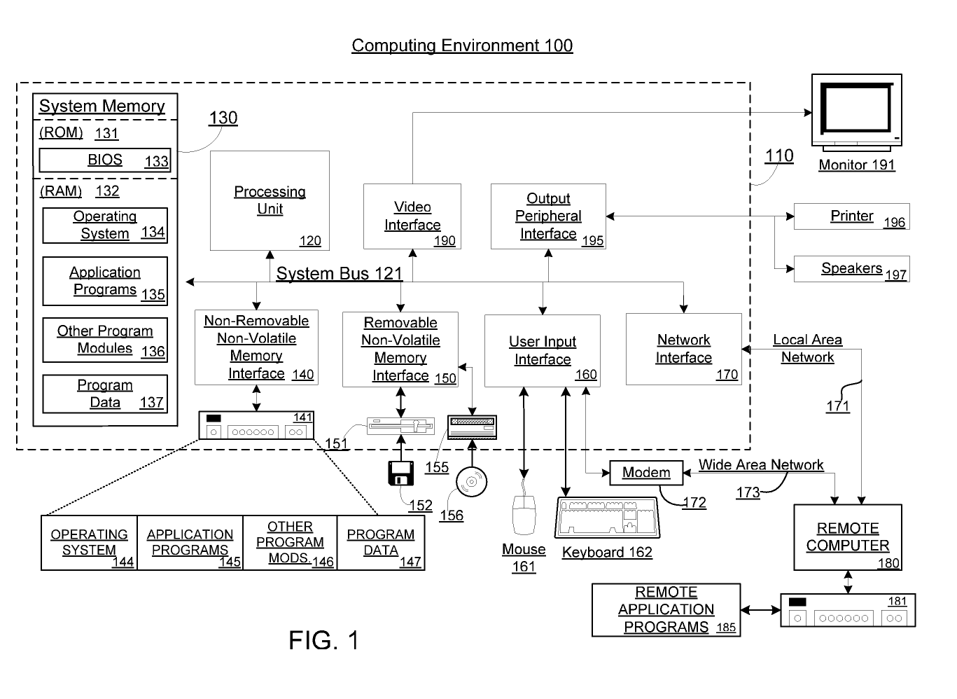

FIG. 1 shows an exemplary computing environment in which example embodiments and aspects may be implemented. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

Numerous other general purpose or special purpose computing system environments or configurations may be used. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

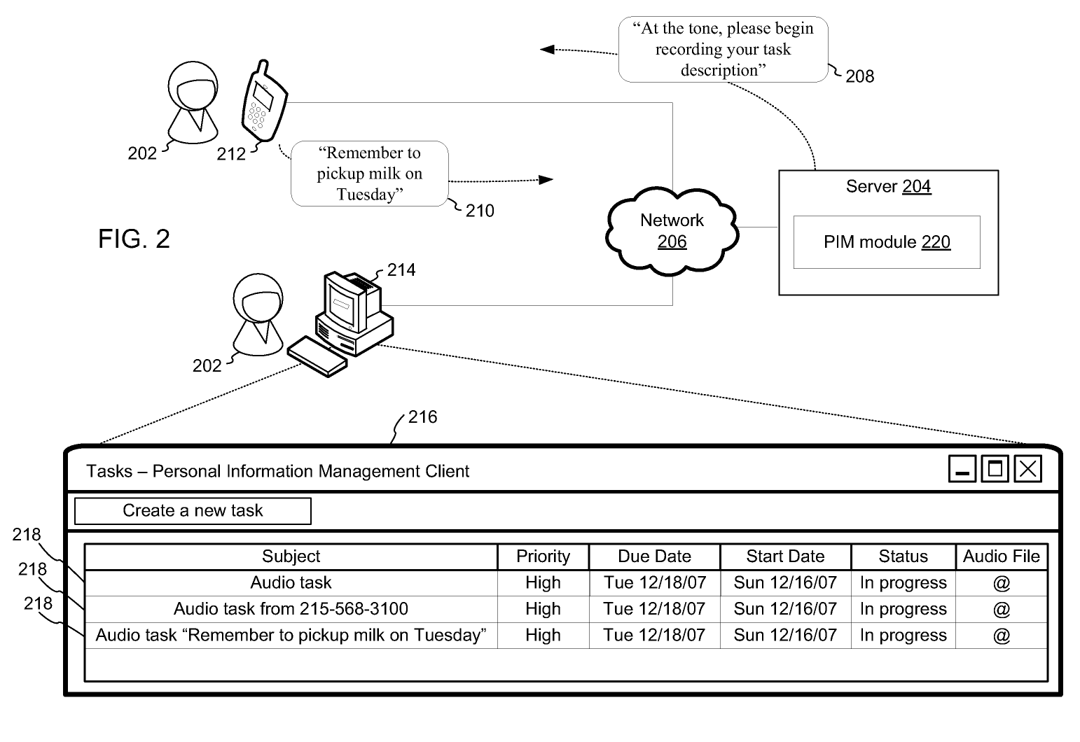

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### Personal Information Management System

FIG. 2 is a block diagram of an example personal information management (PIM) system for creating task objects 218 via an audio user interface. The disclosed system allows a user 202 to place a voice call to a server computer 204 by way of a network 206 and an audio client 212. The user 202 may have an audio interaction with the server computer 204. The server computer 204 may send to the user one or more audio prompts 208 and/or receive from the user one or more responses 210. The interaction may enable the user 202 to create, to edit, and/or to listen to task objects 218 during the call. For example, when the user 202 is away from the office, the user 202 may call the server 204 using an audio client 212, such as a cellular telephone, to access task objects 218. When the user 202 is back in the office, the user 202 may access task objects 218 from a client computer 214. The client computer 214 may include a graphical user interface (GUI) 216 that enables the user 202 to create, edit, listen to, and/or view task objects 218.

To illustrate, the user 202 may be away from the office and may have a thought that the user 202 wishes to capture as a task object 218 in the PIM system. The user 202 may place a telephone call to the PIM server 204. The PIM server 204 may answer the call and, in the course of an audible interaction with the user 202, perform user authentication using a personal identification number (PIN) and/or prompt the user 202 for the subject of the task object 218 that the user 202 wishes to create. For example, the PIM server 204 may prompt the user 202 playing an audible prompt 208 that states, “At the tone, please begin recording your task description.” In response, the user 202 states an audible response 210, such as “Remember to pickup milk on Tuesday,” in the audio stream of the telephone call. The PIM server 204 may associate the audio stream with a task object 218 and store the resultant task object 218 with the user's other task objects 218 in the PIM system. For example, the PIM server 204 may store the new task object 218 such that it is viewable in a task list. The PIM server 204 may process the audible response 210 for presentation and storage in the task object 218. The PIM server 204 may apply a speech recognition process to the audible response 210 and store the resultant text as metadata of the task object, such as in the “Subject” of “Body” of the task object 218.

The PIM server 204 is accessible to the user 202 via client 212, 214 and the network 206. The network 206 may be any system, subsystem, device or collection thereof suitable for communicating voice and/or data. The network may include the public switched telephone network (PSTN), a packet network, a wireless network, an Internet Protocol network, a private network, a public network, a virtual private network, etc., and any combination thereof. The network 206 provides communications between the server computer 204 and the client computer 214. The network 206 provides communications between the server computer 204 and the user's audio client 212. In an embodiment, the network may include a PSTN for communication between the audio client 212 and the server computer 204 and a private corporate data network between the client computer 214 and the server computer 204.

The server computer 204 may include any hardware, software, or combination thereof suitable for executing computer applications, processing information, and storing data. For example, the server computer 204 may include a hardware platform and/or a virtual machine platform. The server computer 204 may include a personal information management (PIM) module 220. The PIM module 220 may include the software and/or hardware to support a personal information management applications, such as e-mail management, calendar management, contact management, notes management, tasks management, or the like. In an embodiment, the PIM module 220 may be a multi-user system. For example, the PIM module 220 may include Microsoft Exchange (Microsoft Corp., Redmond, Wash.), Lotus Notes (International Business Machines, Inc., Armonk, N.Y.), or the like. The PIM module 220 may include audio digitization, text-to-speech (TTS), and/or automatic speech recognition (ASR) functionality.

The audio client 212 may include any device suitable for communicating voice-band audio. In an embodiment, the audio client 212 may support communicating voice-band audio in real-time. For example, the audio client 212 may include a wired telephone, a cellular telephone, a Voice over Internet Protocol (VoIP) telephone, or the like. In an embodiment, the audio client 212 may support communicating voice-band audio in a batch, such as by making a local recording at the audio client 212 and transmitting the resultant audio file. The audio client 212 may include a personal digital assistant (PDA), smart phone, laptop computer, desktop computer, or the like equipped with a microphone.

The client computer 214 may include a PIM client application. The PIM client application may include a graphical user interface (GUI) 216. The PIM client application may interact with the PIM module 220 of the server 204 enabling the user 202 to access the personal information management applications, such as e-mail management, calendar management, contact management, notes management, tasks management, or the like from the client computer 214. For example, the PIM client application may include Microsoft Outlook (Microsoft Corp., Redmond, Wash.) or the like. Alternatively, the PIM client application may include a web browser. The PIM module 220 may serve the interface via hyper text transfer protocol (HTTP) or a similar protocol to the web browser. The web browser may provide display and interaction functionality.

The client computer's GUI 216 may include a task list. The task list may include a representation of at least one task object 218. The task list may be structured in table format. Each task object 218 may include a structured data component and an attached or linked audio file. The structure data component may include data in a predetermined format according to a database schema defined for the task object 218. For example, the structured data component may be formatted as a text field, date field, true/false field, choice box having a limited number of sections, or the like. The audio file may be stored as unstructured data, such as binary large object (BLOB) and/or as a file attached.

As shown, each task object 218 may include a structured data text field labeled “Subject.” The task object 218 may also include other structured data such as Priority, Due Date, Start Date, Status, Date Completed, or the like. One or more of the structured data components may be populated in accordance with the user's audio stream. For example, the Subject may be canned text (e.g., “Audio task”) indicating that the task object 218 was created and/or edited by the user 202 via the audio client 212. Alternatively, the Subject may be text that indicates the calling party telephone number from which the task object 218 was created (e.g., “Audio task from 215-568-3100”). Alternatively, the Subject may be text converted from the user's oral description via speech-to-text conversion (e.g., “Audio task ‘Remember to pickup milk on Tuesday.’”). This speech-to-text conversion may be a best effort speech-to-text conversion.

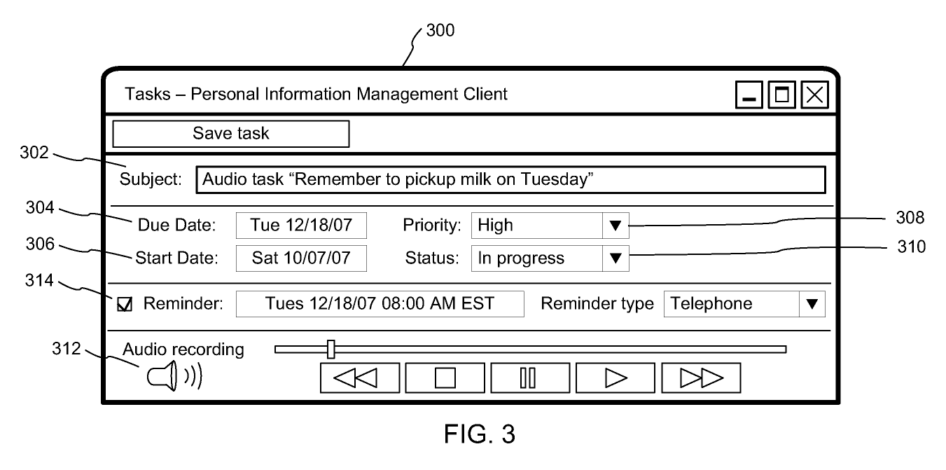

The task list may enable a user 202 to create, edit, and/or delete task objects 218 from the list. For example, the GUI 216 may include a button for creating a new task object 218. The task list, responsive to a double click, may open a task object 218 in a task object GUI 300 as shown in FIG. 3.

FIG. 3 depicts an example task object GUI 300, which may be provided by a client application, such as Microsoft Outlook, for example. The task object GUI 300 may enable a user to create a new task object. The task object GUI 300 may enable a user to edit and/or save changes to an existing task object.

The task object GUI 300 may provide the details of a new and/or existing task object. As shown, the task object may include a structured data field labeled Subject 302. The Subject may be text that defines the task to be performed. The Subject 302 may be a textual version of the spoken-word audio stream, as rendered by an automatic speech recognition (ASR) function and/or human transcription function. The task object may also include one or more structured data fields. Examples of such structured data fields may include, among others, Due Date 304, Start Date 306, Priority 308, Status 310, or the like. The structured data fields may include a Delegation field (not shown) that contains an identifier associated with a person to whom the task has been delegated. If a task is delegated, a copy of the task may appear in the task list associated with the delegated user's account. The task object GUI 300 may provide a media player 312 to listen to the audio stream. The media player 312 may include functional buttons such as play, stop, pause, rewind, and fast forward.

In an embodiment, the task object GUI 300 may include notification information 314. The notification information 314 may indicate whether the user would like a reminder of the task at some specified time in some specified manner. The task object GUI 300 may enable the user to select a time and date for notification. The task object GUI 300 may enable the user to select the type of reminder. For example, the reminder types may include by pop-up computer screen notification, e-mail notification, short message service (SMS) notification, outbound telephone call notification, or the like.

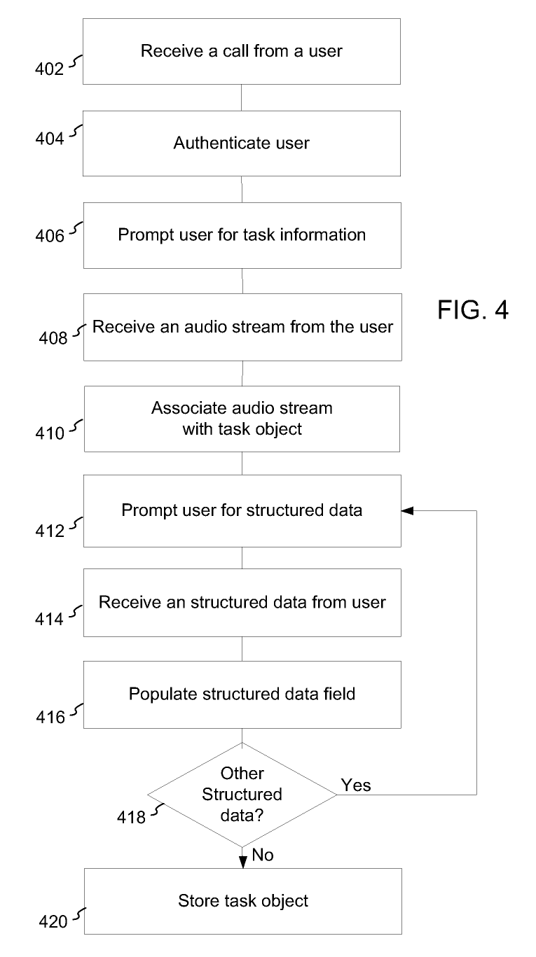

FIG. 4 is flow chart depicting an example process for creating task objects by an audio user interface. At 402, the system may receive an indication from the user that the user wishes to interact regarding task objects. For example, the system may receive a telephone call from the user. In the alternative, user may begin an off-line interaction with digital recorder or personal digital assistant (PDA) that will record the interaction for later processing. The system may receive and answer a telephone call from the user.

At 404, the system may authenticate the user. The system may associate the telephone call with a user account in the personal information management system. The system may prompt the user for a username and/or PIN. The system may have one or more specific dial-in numbers associated with a user, such that every telephone call placed to that number is associated with the user's account. The system may have one or more calling party numbers associated with the user. For example, the user may associate a home telephone number, a cellular telephone number, and/or an office telephone number with the system. The system may check the caller identification field of the incoming call, matching the calling party number to a number stored in connection with the user's account.

At 406, the system may prompt the user for task information. The system may prompt the user to enter whether the user desires to create a new task, or to modify an existing task. For example, the system may play a audible prompt such as “Press or say ‘one’ to create a new task. Press or say ‘two’ to modify an existing task.” The user may respond (e.g., by pressing or saying ‘one’) to indicate that the user desires to create a new task.

The system may invite the user to record a new task description. For example, the system may play a recording such as “At the tone, please begin recording your task description. When you are finished recording your task description, please press the pound key.” The system may alert the user to begin recording the new task Subject. For example, the system may cause a tone to sound so that the user knows to begin recording.

At 408, the system may receive an audio stream from the user. For example, the user may orally and/or audibly describe the task. The server computer may record the user's description. The user may indicate that the description is complete. For example, the user may press the pound key. The recorded description may be stored in memory as a digital audio file. Alternatively, speech-to-text conversion may be used to convert the user's oral description to text, which can be stored in memory as a digital text field. Such a digital text field may be suitable for display in other task-rendering clients. The system may store the text within the structured data field labeled “Subject.” Alternatively, the system may store other data related to the audio stream in the structured data field labeled “Subject.” This other data may include pre-determined “canned” text indicative of an audio created task and/or the calling party telephone number.

At 410, the system may associate the audio stream with the task object. The system may embed the digital audio file within the task object. The system may link the digital audio file to the task object.

At 412, the system may prompt the user to determine whether the user desires to associate any additional structured data with the task. For example, the system may play a prompt such as “Press or say ‘one’ to associate one or more properties with the task.” The user may respond (e.g., by pressing or saying ‘one’) to indicate a desire to associate one or more structured data fields with the new task.

The system may present the user with a list of properties that the user can associate with the task. For example, the system may play a prompt such as “Press or say ‘one’ to provide a Due Date; Press or say ‘two’ to provide a Start Date; Press or say ‘three’ to provide a Status; Press or say ‘four’ to provide a Date Completed; Press or say ‘five’ to provide a Priority.”

The user may select a first of the structured data fields (e.g., by pressing or saying the associated number). The system may present the user with a list of possible values for the structured data, in accordance with a database schema and/or task object protocol. For example, suppose the user selected “Status.” The system may play a recording such as “Press or say ‘one’ if the task is not yet started; press or say ‘two’ if the task is in progress; press or say ‘three’ if the task is completed.” For Priority, the system may play a prompt such as “Press or say ‘one’ for normal priority; press or say ‘two’ for high priority; press or say ‘three’ for low priority. For Due Date, the system may play a recording such as “Enter 01 to 12 or say the month; enter 01 to 31 or say the day, enter a four-digit year or say the year.”

The user may set a Delegation structured data field for the task object. The user may enter a person's name (via DTMF or speech). The system may parse the list of users of the PIM system. The system may match the entered name with the specified user's account. The system may populate the Delegation structured data field with an identifier associated with the delegated user's account. The system may assign the task such that is accessible to both the user who created the task and the user to whom the task has been Delegated. For illustration, the system may prompt, “To set a Delegation for this task, please say a person's name or enter the first four digits of a person's last name.” The user may press the four, eight, three, and seven which correspond to ‘H,’ ‘U,’ ‘D,’ and “S.” The system may parse the list of users for a match and may confirm the match with the user by prompting, “Do you mean ‘Thomas Hudson?’” The user may confirm the match, and an identifier of Thomas Hudson's account may be populated in the Delegation structured data field. The task object may be stored such that it is accessible to Thomas Hudson via his user account. When Thomas Hudson next checks his task list in the PIM system, he may see the Delegated task object and be able to hear the recorded audio stream.

At 414, the system may receive the structured data from the user. The user may select a value for the selected structured data, or indicate that no more are to be associated with the task (e.g., by pressing “#”).

In an embodiment, the system may parse the recognized text for keywords associated with the task object. For example, the user may say “Remember to pickup milk on Tuesday.” The system may parse the recognized text and detect the keyword Tuesday. Then, the system may prompt the user, “Would you like to set a Due date for Tuesday?” Again to illustrate, the user may say “Remember to pickup the milk with high priority. I would like a reminder on Tuesday at 5:30 P.M.” The system may detect the keywords “high priority,” “reminder” and “Tuesday at 5:30 P.M.” Based on the proximity of the keywords and pre-established grammar rules, the system may determine that the user would like the priority structured data field set to ‘high’ and that the user would like a reminder notification on Tuesday at 5:30 P.M. The system may confirm this with an audible confirmation prompt to the user. In addition, the system may prompt the user for more information, such as “Would you like to be reminded by telephone, press or say ‘one;’ by SMS message, press or say ‘two;’ or by computer pop-up screen notification, press or say ‘three.’”

The system may populate one or more of the structured data fields according to a rule set. The rule set may be configured by the user. For example, the user may define a rule set that all start dates be set to the date that the task is created. For example, the user may define a rule set that all reminders after business hours be by telephone and all reminders during business hours be by computer pop-up screen notification.

Similarly, the system may invite the user to set up a reminder notification. For example, the system may play a prompt such as “Press or say ‘one’ if you would like to schedule a reminder for this task?” The user may respond (e.g., by pressing or saying ‘one’) to indicate that the user desires to schedule a reminder for the task. If the user elects to set up a reminder, the system may record the time, date, and notification type from user input. The reminder notification may be stored as structured data within the task object.

At 416, the system may populate the structured data field in accordance with the data received from the user. For example, the system may populate the “Subject” field with recognized text from the received audio stream. For example, the system may populate another field with data derived from DTMF tones received from the user.

At 418, the system may determine if the user would like to include additional structured data. For example, the system may say, “If you would like to assign another property to your task, please press or say ‘one.’” If the user indicates that additional structure data is desired, then the system may again prompt the user for structure data at 412. Otherwise the system concludes the user interaction with regard to the present task object.

At 420, the system may store the task object. In a multi-user system, the system may assign a task identifier that uniquely identifies the task and associates the task with an account associated with the user. The selected values for the selected structured data fields may be associated with the task identifier.

In response to the system prompt at 406 the user may respond (e.g., by pressing or saying ‘two’) to indicate that the user desires to modify an existing task. The system may invite the user to identify the task to be modified. The system may provide a telephony interface to move through the tasks. For example, the system may ask the user to say or enter an identifier associated with the task to be modified. The system may then continue, at 408-420, as described above. Thus, the system may invite the user to modify the Subject of an existing task (e.g., by recording a new one), to modify any of the properties associated with an existing task (e.g., by selecting the property to be modified and then selecting a new value for the property), or to add one or more new properties to an existing task (e.g., by selecting the property to be added and then selecting a value for the property).

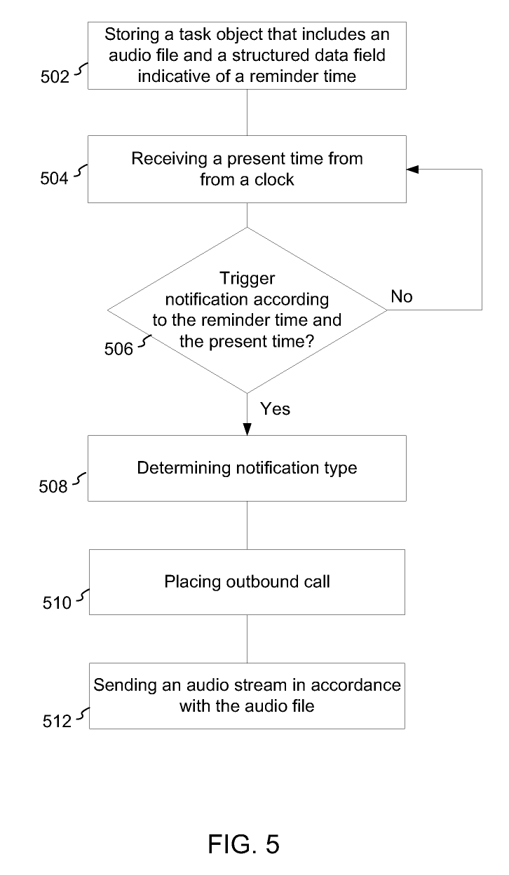

FIG. 5 is flow chart depicting an example process for a reminder notification by an audio user interface. One of the advantages of the audio task object is the ability to support far more flexible notifications—namely out-bound telephone push notifications. The system may call a user's telephone and play to the user, not only machine generated speech associated with the task object but also the original audio stream used to create the task object.

At 502, the system has stored the task object. The task object may include an audio stream and a structured data field indicative of a reminder/notification time. The reminder time may include the data and time of day that user wishes to be reminded and/or notified of the task object. To illustrate, the user may desire a reminder of the task “Remember to pickup milk on Tuesday” at 5:30 P.M. because the user will be heading home from work and the grocery store is on the way. The disclosed system enables users to be reminded of specific tasks at the right time and via a device the user always carries, such as a cellular telephone.

At 504, a present time is received from a clock. For example, a server computer may poll the computer clock for the present time. Alternatively, the server 204 may establish an interrupt associated with clock to trigger at the appropriate reminder time.

At 506, the present time from the clock and the reminder time as stored in the task object may be used to determine whether the reminder/notification is to be triggered. The system may wait until the present time matches or exceeds the reminder time to trigger notification.

At 508, the notification type may be determined. The notification type may be any communication method selectable by the user. For example, the notification type may be e-mail, on-screen “pop-up” notification, short message service (SMS) message, outbound telephone call, or the like. The notification type may be stored with the task object. The notification type may be an predetermined setting associated with the user, for all of the user's tasks. Alternatively, the notification type may be determined by a rule set. For example, the rule set may define computer display-based notifications during business hours and telephone notifications during non-business hours. The notification type may include ancillary data such a the telephone number to call and/or message. The ancillary data may be determined by a rule set as well. For example, place an outbound telephone call to a primary home telephone during the weekdays and to a vacation home telephone on the weekends.

The system may proceed to notify the user in accordance with the notification type. The following illustrates the operation of an outbound telephone notification. A similar process may be followed for other notification types. At 510, the system may place an outbound call to the user, in accordance with the user's notification type and/or ancillary data. Upon the user answering the outbound call, the system may prompt the user for a personal identification number (PIN) to verify that the person answering the call is the authorized user.

At 512, the system plays an audio stream to the user. The audio stream may include canned voice recordings, the audio recorded from the user when the audio task was created, a text-to-speech rendering of any of the structured data fields associated with the task object, and any combination thereof. For example, the system may play, “This is your audio task notification for Tuesday, December 18th. You recorded the following task: ‘Remember to pick up milk on Tuesday.’ If you would you like to get additional details press or say one now.” The user can use the telephone interface (DTMF or speech) to dismiss or otherwise respond to the task.

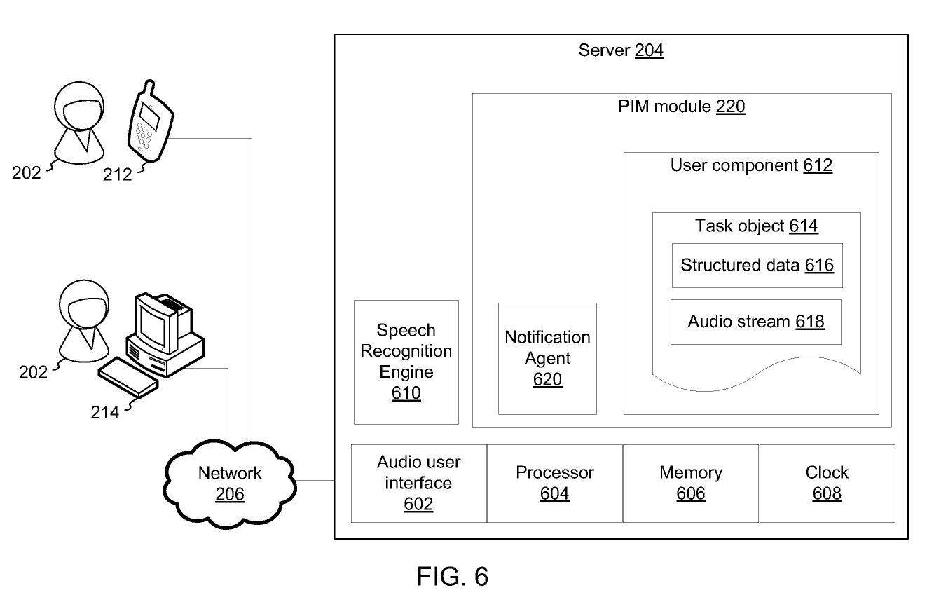

FIG. 6 is a block diagram of an example personal information management (PIM) system for creating task objects and for initiating a reminder notification. A server 204 may be connected to one or more client devices 212, 214. A network 206 may connect the one or more client devices 212, 214 to the server 204. The client devices 212, 214 may include an audio user interface device, such as a cellular telephone. The client devices 212, 214 may include a graphical user interface device, such as a personal computer. The server 204 may comprise an audio user interface 602, a processor 604, a memory 606, a clock 608, a speech recognition engine 610, and/or the PIM module 220.

The audio user interface 602 may include hardware, software, or combination thereof to implement a programmable interaction between a client device and the server 204 via a voice-band audio channel. In an embodiment, the audio user interface 602 may receive a pre-recorded audio file from the user 202. The audio file having been pre-recorded by the user 202 on a personal digital assistant (PDA), digital recorder, or the like. In an embodiment, the audio user interface 602 may include a telephony adapter and/or telephony user interface. The telephony user interface may support automatic speech recognition and/or dual tone multi-frequency (DTMF) detection. The telephony user interface may receive speech data and/or DTMF data from the audio stream 618. In VoIP calls, for example, the DTMF data in the audio stream 618 may include out-of-band data. The telephony user-interface may include telecom and/or networking hardware such as subscriber line cards, Integrated Services Digital Network (ISDN) equipment, Digital Terminal Equipment (DTE), Digital Communications Equipment (DCE), Voice over IP (VoIP) adapters and protocol stacks, or the like. The telephony user interface may include a connection to a Private Branch Exchange (PBX). The connection to the PBX may be circuit switched or packet switched.

The telephony user interface may receive an inbound telephone call. The server 204 may recognize that the inbound telephone call is associated with a user 202 of personal information management system. The server 204 may recognize a personal identification number (PIN) entered by the user 202. The server 204 may have a specific dial-in number assigned to the user 202. The server 204 may recognize the calling party number received by the inbound telephone call, the calling party number may be associated with the user 202. The user 202 may authenticate their identity during the telephone call and associate the audio stream 618 of the telephone call to the user's account with the PIM system.

The processor 604 may direct the audio user interface 602 in a series of prompt and response interactions with the user 202 by way of a voice-band channel. The audio user interface 602 may receive an audio stream 618 from the user 202. The audio stream 618 may include the voice-band audio channel from the telephone call. The processor 604 may direct the audio user interface 602 to play an audible prompt to the user 202. The processor 604 may direct the audio user interface 602 to detect one or more DTMF tones in response to an audible prompt.

The processor 604 may engage a speech recognition engine 610 in connection with the audio stream 618. The audio stream 618 may be inputted to a speech recognition engine 610. The speech recognition engine 610 may detect the users response to one or more of the audible prompts. The speech recognition engine 610 may be any hardware, software, combination thereof, system, or subsystem suitable for discerning and/or identifying a word or words from a speech signal. For example, the speech recognition engine 610 may receive the audio stream 618 and process it. The processing may, for example, include hidden Markov model-based recognition, neural network-based recognition, dynamic time warping-based recognition, knowledge-based recognition, or the like.

The speech recognition engine 610 may receive the audio stream 618 and may return recognition results with associated timestamps and confidences. The speech recognition engine 610 may recognize a word and/or phrase from the audio stream 618 as a recognized instance. The recognized instance may be associated with a confidence score. The confidence score may include a number associated with the likelihood that the recognized word and/or phrase correctly matches the spoken word and/or phrase from the audio stream 618.

In an embodiment, the speech recognition engine 610 may provide near real-time speech recognition. In an embodiment, the speech recognition engine 610 may provide speech recognition in batch processing. The audio stream 618 from the telephone call may be stored for latter processing by the speech recognition engine 610. Alternatively, the audio stream 618 may be sent to a human operator for human transcription.

The server 204 may host a PIM module 220. The PIM module 220 may include any hardware, software, or combination thereof, suitable for managing personal information such as e-mail, calendar, contacts, notes, tasks, or the like. The PIM module 220 may be based on a database platform. The data associated with the PIM module 220 may be stored in one or more tables. Functionality associated with the PIM module 220 may be provided by one or more tables, views, queries, or the like. Each table associated with the PIM module 220 may have a schema. The schema may define the structure and nature of the data stored within the table.

The PIM module 220 may include one or more user components 612. Each user component 612 may be associated with a user of the PIM system. The user component 612 may include data and applications associated with a particular user 202. For example, an individual user's, e-mail, calendar, contacts, notes, tasks, or the like, may be stored as part of the user component 612. The user component 612 may contain settings, configurations, rule sets, applets, or the like that are specific to an individual user. In a multiple user system, each user component 612 may be associated with a user account of the PIM system.

The user component may store one or more task objects 614 associated with the user 202. Typically, the task object 614 may be used by the user 202 to indicate an item in a list. For example, a user 202 may store and one or more task objects 614 of projects to be completed. A user 202 may store one or more task objects 614 of actions to do.

The task object 614 may be one or more database tables, rows, columns, the combination thereof, or the like associated with the user 202. The task object 614 may be defined by a schema. The task object 614 may include a structure data component 616 and/or an audio stream 618.

The structured data 616 may include data that has been predefined of a particular format and/or type. For example, the schema may define task object 614 as having the following structured data fields 616: a text field labeled subject, date fields labeled due date, start date, a reminder date, selection fields labeled parity, status, reminder type, or the like.

The task object 614 may include an un-structured component such as an audio stream 618. The unstructured component may be binary data not predefined as a particular format, and/or meaning within the PIM system. The audio stream 618 may correspond to a portion of the audio received via the audio user interface 602 during an inbound telephone call from the user 202. The audio stream 618 may correspond to a portion of the audio received via the client device 212.

The audio stream 618 may be embedded in the task object 614. The audio stream 618 may be encoded as a binary large object (BLOB) and stored within the task 614 itself (i.e, within a table in the underlying database system). Alternatively, the audio stream 618 may be linked to the task object 614 (i.e., the table in the underlying database system stores a link to the audio stream 618). The task object 614 may include a pointer to an audio file stored on a file system of the server 204.

The processor 604 may associate an audio stream 618 received via the audio user interface 602 with a task object. The processor 604 may populate a structured data field of the task object with information indicative of the audio stream 618. For example, the processor 604 may direct the speech recognition engine 610 to recognize human speech from the audio stream 618 and convert the audio stream 618 to text. The processor 604 may populate a structure data field of the task with the text of the audio stream 618. The processor 604 may populate the structured data field 616 of the task with a predefined text string, such as “audio task.” The processor 604 may populate the structured data field 616 of the task with a dynamic text string. For example, the processor 604 may include the calling party number in the text string, such as “audio task—215-564-3100.”

The task object may be stored in memory 606. The memory 606 may include volatile memory and/or nonvolatile memory. For example, the memory 606 may include random access memory. The memory 606 may include flash memory, physical memory, hard disc memory, or the like.

The task object 614 can be stored such that it is presented in a task list. The user 202 may view a task that has been created via the audio user interface 602 along with all of the other tasks created by the user 202. The task list may be presented to the user 202 via the client computer 214.

The server 204 may include a notification agent 620. The notification agent 620 may provide functionality on behalf of the user 202 at the server 204. For example, the notification agent 620 may determine that a reminder has come due and may notify the user 202 of the reminder. A reminder may be associated with a task object 614. The reminder may include a date and time which will trigger notification of the user 202. The reminder may include in notification type, such as graphical pop-up window, outbound telephone call, SMS message, or the like.

The clock 608 may be any hardware, software, or combination thereof suitable for keeping time. The clock 608 may include a hardware quartz counter. The clock 608 may include functionality to maintain time from other servers. For example, the clock 608 may support Network Time Protocol (NTP).

In accordance with the notification agent 620, the processor 604 may compare a present time received from the clock 608 with the reminder time of the task object 614. When the clock 608 time matches and/or exceeds the reminder time, the processor 604 may trigger a notification event. The notification agent 620 may determine the notification type from the task object. The notification agent 620 may notify the user 202 that the task object 614 has come due, in accordance with the notification type. For example, the notification agent 620 may launch an SMS message, where the body of the SMS message includes the subject of the task (which may include text as converted from the audio stream 618).

The notification agent 620 may launch an outbound telephone call to the user 202. Upon answer, the notification agent 620 may direct the audio user interface 602 to request a PIN from the user and/or to play one or more audible messages. The notification agent 620 may direct the audio user interface 602 to play the audio stream 618 from the task object to the user 202. To illustrate, the user 202 may leave work on Tuesday evening at 5:15 P.M. Once in the car for the commute home, the user's cellular telephone rings. The user 202 answers the telephone and, after entering a PIN, hears the following, “This is a reminder from your personal information management system. The subject of your task is ‘remember to pick up milk on Tuesday.’ You created this task on Sunday, December 16. Would you like to dismiss this reminder? Press or say ‘one.’ Would you like to snooze this reminder? Press or say ‘two.’ If you would like more information about this task item, press or say ‘three.’ If you would like to edit this task, press or say ‘nine.’” In response the user 202 presses ‘one’ on the keypad, and having been reminded, stops to pickup milk on the way home.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for creating a task object, the system comprising:
a telephony interface to receive an audio stream over an inbound telephone call, wherein the audio stream is associated with a user account of a personal information management system;
a speech recognition engine, in communication with the telephony interface, wherein the speech recognition engine converts the audio stream to text;
a processor in communication with the speech recognition engine, wherein the processor associates the audio stream with a task object, populates a first structured data field of the task object with the text, and associates the task object with the user account; and
a memory in communication with the processor, wherein the memory stores the task object, such that task object is presentable in a task list associated with the user account.

2. The system of claim 1, wherein the task object comprises a second structured data field, wherein the processor populates the second structured data field in accordance with a prompt and response interaction over the telephony interface.

3. The system of claim 1, wherein the task object comprises a second structured data field, wherein the processor populates the second structured data field in accordance with a keyword detected from the text.

4. The system of claim 1, wherein the task object comprises a second structured data field, wherein the second structured data field is identified by any of calling party number, due date, start date, priority, status, percentage complete, or category, and wherein the task list shows the first structured data field and the second structured data field.

5. A method of creating a task object in a personal information management system, the method comprising:
receiving an audio stream;
responsive to the receiving, associating at least a portion of the audio stream with a task object;
populating a first structured data field of the task object with data relating to the audio stream; and
storing the task object, such that task object is presentable in a task list.

6. The method of claim 5, further comprising receiving a telephone call, wherein the audio stream is derived from the telephone call.

7. The method of claim 5, further comprising receiving a pre-recorded audio file, wherein the audio stream is derived from the pre-recorded audio file.

8. The method of claim 5, further comprising initiating a voice prompt, wherein receiving the audio stream is responsive to the voice prompt.

9. The method of claim 5, wherein the data relating to the audio stream comprises text resulting from speech recognition processing of the audio stream.

10. The method of claim 5, wherein the data relating to the audio stream comprises predetermined text.

11. The method of claim 5, wherein the data relating to the audio stream comprises a calling party number.

12. The method of claim 5, wherein the associating comprises embedding the at least a portion of the audio stream in the task object.

13. The method of claim 5, wherein the associating comprises linking the at least a portion of the audio stream in the task object.

14. The method of claim 5, further comprising populating a second structured data field, wherein the second structured data field is identified by any of calling party number, due date, start date, priority, status, percentage complete, or category.

15. The method of claim 5, further comprising parsing audio stream for a recognized key word, and populating a second structured data field in accordance with the recognized key word.

16. The method of claim 5, further comprising populating a second structured data field from an prompt and response interaction.

17. The method of claim 5, further comprising populating a second structured data field according to a default rule set.

18. A system for pushing notifications to a client, the system comprising:
a processor;
a clock in communication with the processor;
a memory in communication with the processor, wherein the memory is adapted to store a task object, wherein the task object comprises a structured data field indicative of a reminder time and an audio file; and
a telephony interface in communication with the processor; wherein the telephony interface is adapted to play the audio file over an outbound call placed at a first time, the first time being determined by the processor based on a second time received from the clock and the reminder time of the task object.

19. The system of claim 18, wherein the telephony interface is a voice over IP interface.

20. The system of claim 18, wherein the task object is associated with a user account of a personal information management system, and wherein the outbound call is placed to a called party number associated with the user account.
